(19) United States
(12) Patent Application Publication
(10) Pub. No.: US 2014/0345723 A1
(43) Pub. Date: Nov. 27, 2014

(54) WATER INJECTION DEVICE FOR A BYPASS STEAM SYSTEM OF A POWER PLANT

(71) Applicant: Siemens Aktiegesellschaft, Munich (DE)

(72) Inventor: Frank Deister, Willich (DE)

(73) Assignee: Siemens Aktiengesellschaft, Munich (DE)

(21) Appl. No.: 14/371,940

(22) PCT Filed: Nov. 7, 2012
(86) PCT No.: PCT/EP2012/071984

§ 371 Date: Jul. 11, 2014

(30) Foreign Application Priority Data
Jan. 25, 2012 (EP) 12152417.7

(51) Int. Cl. F16L 41/02

(52) U.S. Cl. CPC F16L 41/02
USPC 137/602

(57) ABSTRACT

A water injection device for a bypass steam system of a power plant, having a flow channel for steam with a steam inlet and a steam outlet, and an injection nozzle which is arranged between the steam inlet and outlet, is provided having a particularly satisfactory cooling action in order to avoid condenser damage by way of technically particularly simple means. To this end, the injection nozzle is arranged on a wall which extends substantially in the direction of the gas flow and is arranged spaced apart from an inner wall of the flow channel.

### CROSS REFERENCE TO RELATED APPLICATIONS

This application is the U.S. National Stage of International Application No. PCT/EP2012/071984 filed Nov. 7, 2012, and claims the benefit thereof. The International Application claims the benefit of European Application No. EP12152417 filed Jan. 25, 2012. All of the applications are incorporated by reference herein in their entirety.

### FIELD OF INVENTION

The invention relates to a water injection device for a bypass steam system of a power plant, comprising a flow duct for steam having a steam inlet and a steam outlet, and an injection nozzle arranged between the steam inlet and outlet.

### BACKGROUND OF INVENTION

Power plants for generating electrical energy usually use the thermal energy of a combustion process to generate mechanical energy which is then converted to electrical energy in a generator. Direct-fired steam generators, which generate steam for a steam turbine, are frequently used for this. However, the thermal energy for generating steam can also be obtained from other sources such as nuclear energy. Another possibility, which does away with the detour via the generation of steam, is for example a direct conversion in a gas turbine. In this case, too, however, the hot exhaust gases of the gas turbine are frequently also used in a waste heat boiler for generating steam. In summary, steam is therefore used for generating electricity in most power plants.

The steam necessary for the operation of the steam turbine is generated in a boiler from previously purified and prepared water. By further heating the steam in the superheater, the temperature and the specific volume of the steam increase. From the boiler, the steam flows via pipes into the steam turbine where it gives off, as kinetic energy to the turbine, part of its previously absorbed energy. A generator, which converts the mechanical power into electrical power, is coupled to the turbine. The expanded and cooled steam then flows into the condenser, where it condenses by transfer of heat to the surroundings and collects at the deepest point of the condenser as liquid water. The water is stored temporarily in a feed water container by the condensate pumps and the preheater, and is then supplied again to the boiler by the feed pump.

In certain operating states, for example when starting up the steam turbine or in the event of a trip, i.e. a more or less uncontrolled acceleration of the steam turbine rotor, it is necessary to guide hot steam flow past the turbine in order to reduce the power. Since the condenser is typically not configured for such superheated steam, a special bypass steam system is required, in which the fresh steam is expanded and cooled by injection of water. Otherwise, the condenser could be damaged.

In that context, the water injection device typically comprises a plurality of injection nozzles arranged between its inlet and outlet. These are commonly arranged on the enclosure wall of the steam duct of the water injection device.

### SUMMARY OF INVENTION

It is now an object of the invention to propose a water injection device for a bypass steam system of a power plant of the type mentioned in the introduction, which has a particularly good cooling effect in order to avoid damage to the condenser with technically particularly simple means.

This object is achieved according to the invention in that the injection nozzle is arranged on a partition which extends substantially in the direction of the gas stream and is arranged at a distance from an internal wall of the flow duct.

The partition has a flat profile on its side facing the internal wall. As a consequence, the steam flow between the internal wall and the partition is minimally hampered and remains largely unaffected with respect to its flow speed and temperature. On one hand, this maximizes the already mentioned shear layer formation; on the other hand, the region on the internal wall thus remains particularly hot, such that water which is transported in the direction of the internal wall evaporates particularly well and is not deposited, unused, on the internal wall.

The invention proceeds from the assumption that a particularly good cooling effect could be achieved, if a more homogeneous distribution of the water in the steam jet could be achieved. A more homogeneous distribution leads in particular to a more complete evaporation of the injected water and thus to a more even steam temperature at the inlet to the condenser. It was recognized in this context that injection at the internal wall between the steam inlet and steam outlet, as has been common up to now, is disadvantageous since the water injected at the edge does not penetrate as far as the core of the steam jet, even if the internal wall is narrowed at the injection point and is closer to the core of the steam flow. The reason for this is the high speed of the steam. For this reason, the injection nozzle should be arranged on a partition of the flow duct which is spaced apart from the internal wall. This produces a position of the injection nozzle closer to the core of the steam flow since, as a consequence of the steam flow being split in two, already part of the steam flow is guided between the partition and the internal wall, and thus the nozzle itself is arranged closer to the core of the steam flow in spite of the flow rate being the same.

In an advantageous configuration, the injection nozzle is arranged on that side of the partition which faces away from the internal wall, i.e. toward the core of the flow. On one hand, this avoids part of the water being deposited, unevaporated, on the internal wall and thus not contributing to the cooling. On the other hand, the partial steam flow between the partition and the internal wall remains without injection and there results a difference in temperature and in flow speed between the partial steam flow between the partition and the internal wall and the partial steam flow on the other side of the partition. These partial steam flows are reunited in the end region of the partition, behind the injection nozzle. As a consequence of the flow speed difference, a strong shear layer develops here which mixes water and the two partial flows even better by turbulence.

Advantageously, the injection nozzle is arranged on a section of the partition which is inclined toward the internal wall in the direction of the steam inlet, i.e. in a region of widening available cross section for the partial steam flow which flows on that side of the partition which faces away from the internal wall. Furthermore, the partition advantageously has a curved profile on its side facing away from the internal wall, so that, together with the abovementioned arrangement of the injection nozzle, the nozzle is arranged behind the curved portion in the flow direction. A high steam speed, and therefore a reduced steam pressure, prevails here, which favors the injection of water. On account of the high steam speed, the water is in addition atomized particularly finely.

Advantageously, the internal wall forms a cylindrical section. Such a configuration of the water injection device is of particularly simple construction and permits, by virtue of the radial symmetry, a particularly homogeneous steam flow.

Similarly, the partition forms a cylindrical section which is concentric with the internal wall, the partition accordingly forms a cylindrical enclosure and can be attached to the internal wall, for example by appropriate struts. The struts should have, as seen in the flow direction, a cross section which hampers the steam flow as little as possible. The supply of the injection water can also be arranged in the struts. By the abovementioned configuration, the steam flow is thus divided into a central main flow and a peripheral bypass flow. The shear layer thus also forms the shape of a cylindrical enclosure, by which, on account of the symmetry, a particularly homogeneous mixing is made possible.

In order to further improve the homogeneity of the mixing, a plurality of injection nozzles are advantageously arranged with radial symmetry.

A bypass steam system for a power plant advantageously comprises such a water injection device and a power plant advantageously comprises such a bypass steam system.

The advantages achieved by the invention include in particular that, by dividing the steam flow and injecting water in only one partial flow, a shear layer is formed which substantially improves the mixing and atomization of the injected water by film atomization from both sides, and thereby a particularly good cooling effect in the bypass steam system is achieved. In addition, the high temperature of the partial steam flow flowing past the internal wall avoids water being deposited here.

### BRIEF DESCRIPTION OF THE DRAWINGS

The invention is described in more detail with reference to a drawing, in which:

FIG. 1 shows a water injection device having injection nozzles arranged on the internal wall according to the prior art, and

FIG. 2 shows a water injection device having injection nozzles which are arranged on a partition which is arranged at a distance from the internal wall.

Identical parts are provided with the same reference signs in all figures.

### DETAILED DESCRIPTION OF INVENTION

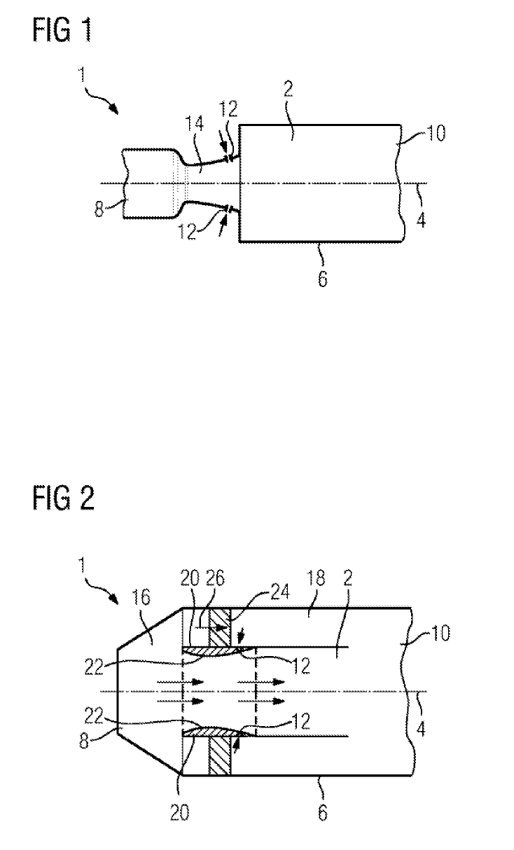

The water injection device 1 according to FIG. 1 comprises a flow duct 2 which is surrounded by an internal wall 6 which is arranged with radial symmetry about an axis 4. The steam inlet 8 is located on the left-hand side in FIG. 1, the steam outlet 10 is on the right. The cross section of the steam inlet 8 is smaller than that of the steam outlet 10. Therefore, the underexpanded jet, which results downstream of the convergent-divergent nozzle 14, does not touch the internal wall 6.

The water injection device 1 is a component of a bypass steam system of a power plant which is not represented in more detail. A bypass valve, which is connected upstream of the steam inlet 8 and by which steam flow is guided from the steam generator of the power plant, past the steam turbine, through the bypass steam system directly into the condenser connected downstream of the steam outlet 10, is not shown. This can be necessary in certain operating states, for example when starting up the steam turbine or after a trip.

The steam is cooled in the water injection device 1 such that it can be fed into the condenser without damaging the latter. To that end, in the water injection device 1, injection nozzles 12, which inject water into the steam flow, are arranged at the outlet of a narrowing section 14. In the embodiment according to FIG. 1, the water does not reach the axis 4 and thus the core of the steam flow in spite of the high steam speed (typically supersonic speed) in section 14. In addition, part of the water reaches the internal wall 6 unevaporated and is deposited there.

In the water injection device 1 according to FIG. 2, by contrast, the mixing of the water with steam and the atomization of the water are substantially improved. As seen in the flow direction, the internal wall 6 first forms downstream of the steam inlet 8 a widening conical section 16 to which a cylindrical section 18 is connected. Directly after the transition into the cylindrical section 18, a partition 20, which is substantially in the shape of a cylindrical enclosure, is arranged at a distance from the internal wall 6 and symmetrically about the axis 4.

The partition 20 has a flat profile facing the internal wall 6. The partition is curved toward the axis 4. The injection nozzles 12 are arranged with radial symmetry on that side of the curved portion 22 which faces the steam outlet 10. The partition 20 is attached to the internal wall by struts 24. The cross section and the profile of the struts 24 are configured such that the steam flow is hampered as little as possible. The water supply 26 is also arranged in the struts 24.

By the configuration shown in FIG. 2, the steam flow is split into one partial flow between the partition 20 and the internal wall 6 and one partial flow inside the partition 20. Water is injected only into the inner partial flow, whereby the latter cools down. Behind the partition, as seen in the flow direction, a shear layer 28 forms when the two partial flows are reunited. This provides particularly good mixing of the two partial flows and thus also a further atomization and mixing of the water with the steam.

1. A water injection device for a bypass steam system of a power plant, comprising:
a flow duct for steam having a steam inlet and a steam outlet, and an injection nozzle arranged between the steam inlet and outlet,
wherein the injection nozzle is arranged on a partition which extends substantially in the direction of the gas stream and is arranged at a distance from an internal wall of the flow duct, and
wherein the partition has a flat profile on its side facing the internal wall.

2. The water injection device as claimed in claim 1, wherein the injection nozzle is arranged on that side of the partition which faces away from the internal wall.

3. The water injection device as claimed in claim 1, wherein the injection nozzle is arranged on a section of the partition which is inclined toward the internal wall in the direction of the steam inlet.

4. The water injection device as claimed in claim 1, wherein the partition has a curved profile on its side facing away from the internal wall.

5. The water injection device as claimed in claim 1, wherein the internal wall forms a cylindrical section.

6. The water injection device as claimed in claim 5, wherein the partition forms a cylindrical section which is concentric with the internal wall.

7. The water injection device as claimed in claim 5, wherein a plurality of injection nozzles are arranged with radial symmetry.

8. A bypass steam system for a power plant having a water injection device as claimed in claim 1.

9. A power plant having a bypass steam system as claimed in claim 8.
